(19) United States
(12) Patent Application Publication
(10) Pub. No.: US 2010/0099446 A1
(43) Pub. Date: Apr. 22, 2010

(54) METHOD AND NODE FOR SELECTING CONTENT FOR USE IN A MOBILE USER DEVICE

(75) Inventors: Saswat Panigrahi, Montreal (CA); Truong Ta, Dollard-des-Ormeaux (CA); Ricardo Badette, Repentigny (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/416,690

(22) Filed: Apr. 1, 2009

Related U.S. Application Data
(60) Provisional application No. 61/107,544, filed on Oct. 22, 2008.

(51) Int. Cl. H04W 4/12

(52) U.S. Cl. 455/466

(57) ABSTRACT

The invention relates to a node and to a method, in a telecommunications system, for selecting one of a plurality of contents, such as advertisement, for use in a mobile user device. The node comprises an access module, for accessing mobile user information corresponding to criteria relative to the plurality of contents which are contained in a memory. The node also comprises a processing module for selecting the content for use in the mobile user device based on a total score calculated for each content of the plurality of contents, the total score of each content being calculated by adding correspondence scores calculated between each criterion and the mobile user information corresponding to each criterion.

### PRIORITY CLAIM

This application claims the benefit of priority of U.S. Application No. 61/107544, filed Oct. 22, 2008, the entire contents of which is incorporated herein by reference.

### TECHNICAL FIELD

The present invention relates to a method for selecting one of a plurality of contents for use in a mobile user device and more particularly for selecting an advertisement for use in the mobile user device.

### BACKGROUND

Today, messaging is omnipresent. The quantity of Short Message Service (SMS), Multimedia Messaging Service (MMS), emails and other multimedia content exchanged between users of mobile user devices is very important and is still growing.

The availability of this multitude of messaging means opens the door to multimedia advertisement and content targeting. Advertisements (Ads) for displaying in a mobile device, for example, can be much more targeted than any other Ads available on the web, given that the identity and the location of a user device can be inferred. Further the content of messages communicated through the mobile device offers a great source of information useful for targeted advertising.

Google® AdSense, Yahoo® Search Marketing and Microsoft® adCenter are based on Information Retrieval based Targeting (IRT). These technologies insert advertisements into web pages. For example, by using text based matching between a query entered by a user and an Ad, or by using text based matching between the content of a web page and an Ad.

In the mobile arena, there are some extensions of the above into mobile web. When a user visits a mobile webpage the user device receives advertisements which are targeted based on the content of the mobile webpage.

Some location based targeting (LBT) techniques also exist which compile statistics of user location patterns. However, in the web arena, generally, the user is anonymous.

Theoretically, it is possible to pull information from a database about profile information for a user and to use it for Ads targeting. However when targeted advertisement is done in real-time, due to technical complexity, most methods only use very basic information such as “age” or “income”. In these methods, when a triggering event occurs, the user data is queried from a cache, a data warehouse or a consumer information database. Such techniques are called User Profile based Targeting (UPT).

In other cases, mobile operator, advertiser or media agency determines offline, with the help of a survey or of an external agency, a list of users within a certain age group or certain interests. Then, this list serves as a distribution list for advertisements or content. This type of distribution list based methods is referred to as Offline Targeting Methods (OTM).

Known in the art is US patent application publication no. US 2008/0281910 A1, pertaining to Trioano et al., which describes a system and method to enable an organization to acquire a user mobile device address, to respond to a user and to deliver mobile messages, coupons, offers and promotions to users of mobile device, by means of a combination of a trigger system, a message application server and an offer application. Trioano teaches an external trigger system which is not based, however, on the mobile user device data messaging capabilities. Upon the external trigger, the trigger system informs the message application server which sends a message to the mobile user device.

Also known in the art is European patent application publication no. EP 1 940 120 A1, pertaining to Carvajal Y Urquijo et al., which describes a system and method for providing personalized advertisements to users of electronic communications devices. However, this document fails to teach how, according to a type of user determined from a user's profile, the advertisement is selected.

Thus, there is a need for an improved method for targeting Ads for mobile user devices, using more of the available information from mobile user devices and using this information in a more targeted way.

### SUMMARY

It is therefore an object of this invention to provide a method and a node for selecting one of a plurality of contents for use in a mobile user device.

According to an aspect of the invention, a node in a telecommunications system is provided. The node comprises a memory containing a plurality of contents. The node also comprises an access module, for accessing mobile user information corresponding to criteria relative to the plurality of contents. The node further comprises a processing module for selecting a content for using in the mobile user device based on a total score calculated for each content of the plurality of contents, the total score of each content being calculated by adding correspondence scores calculated between each criterion and the mobile user information corresponding to each criterion.

According to another aspect of the invention, a method for selecting one of a plurality of contents for use in a mobile user device is provided. The method comprises the step of accessing mobile user information corresponding to criteria relative to the plurality of contents. The method also comprises the following steps, executed for each content of the plurality of contents: calculating a correspondence score between each criterion of the content and the mobile user information corresponding to each criterion and calculating a total score by adding the correspondence scores of the content. The method also comprises the step of selecting the content for using in the mobile user device based on the total score calculated for each content.

### BRIEF DESCRIPTION OF THE DRAWINGS

The objects and advantages of the invention will be understood by reading the detailed description in conjunction with the figures, wherein:

FIG. 1 is a schematic illustration of mobile user information according to an exemplary embodiment of the invention;

FIG. 2 is a block diagram of a node, a mobile device and a secondary node according to an exemplary embodiment of the invention;

FIG. 3 is a table illustrating algorithms storage according to an exemplary embodiment of the invention;

FIG. 4 is a flowchart illustrating the steps of a method according to an exemplary embodiment of the invention;

FIG. 5 is a schematic representation of an exemplary embodiment of the method of the present invention; and

FIG. 6 is a schematic representation of an exemplary system embodying the method of the present invention.

### DETAILED DESCRIPTION

The various features of the invention will now be described with reference to the figures. These various aspects are described hereafter in greater detail in connection with exemplary embodiments and examples to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions or functions to be performed by elements of a computer system or other hardware capable of executing programmed instructions. It will be recognized that the various actions could be performed by specialized circuits, by program instructions being executed by one or more processors, or by a combination of both. Moreover, the invention can additionally be considered to be embodied entirely within any form of computer readable carrier, such as solid-state memory, magnetic disk, optical disk or carrier wave, such as radio frequency, audio frequency or optical frequency carrier waves, containing an appropriate set of computer instructions that would cause a processor to carry out the techniques described herein. Thus, the various aspects of the invention may be embodied in many different forms, and all such forms are contemplated to be within the scope of the invention.

The embodiments according to the present invention are described with reference to block diagrams and/or operational illustrations of methods, servers, and computer program products. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed; these are generally illustrated with dashed lines.

Selection of targeted content, such as advertisement, for use in mobile user devices, including cell phones and all other kinds of communication enabled devices, is quite challenging. Current solutions lack the ability to match different classes of user information to a wide range of criteria of different types. Furthermore, current solutions lack scalability i.e. new criteria may be hard to add when they become available. The present invention remedies this situation with a node and a method providing an expandable, customizable selection of content for use in mobile user devices, where the matches of different criteria can be evaluated in different manners, with different algorithms and where some or all user information can be acquired in real time.

The present invention may be used, for example, for the insertion of a targeted advertisement in the body of a message sent from one mobile user device to another. To do so, the system of the invention may acquire instant information of the mobile user device or information of the mobile user device already stored in a database. The system may also acquire information such as the content of the message itself. The system then uses this information for comparison with criteria of advertisements stored in a database. An advertisement best corresponding to the information is then selected and inserted in the message, for example.

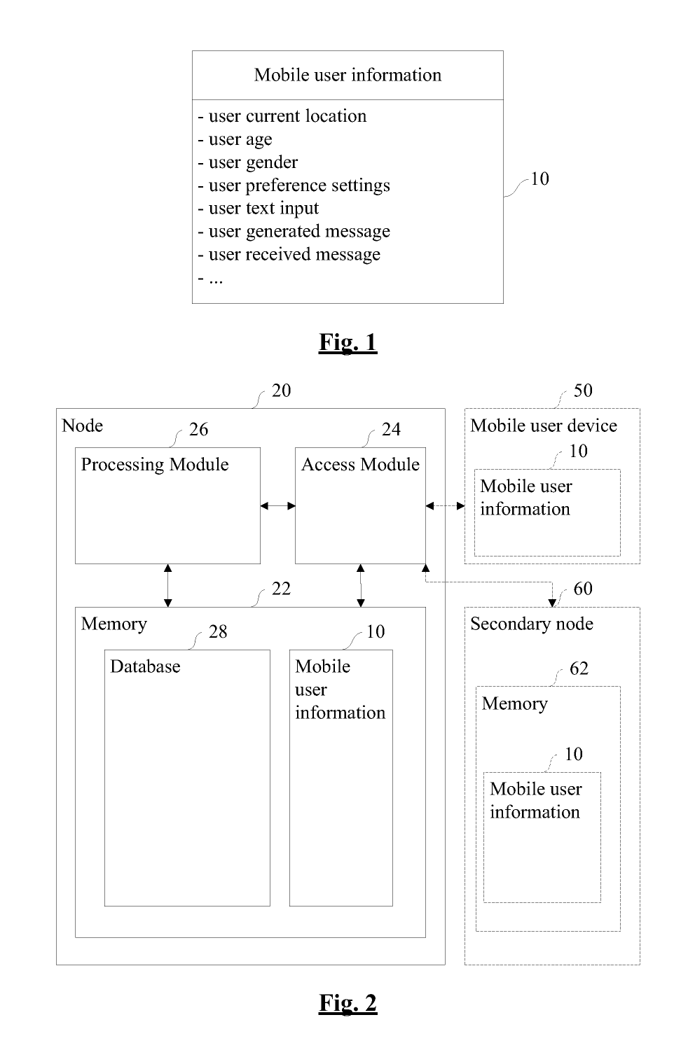

FIG. 1 is a schematic illustration of mobile user information 10. This mobile user information 10 may be accessible from a mobile user device in real time or may be stored in a memory of the mobile user device. This information 10 may also be stored and updated in another node, such as a server, where information pertaining to many mobile users may be stored and may be available. This information 10 may further be kept in any data storage in a communications system and can be fragmented. Of course, information such as content of a message may be added to the mobile user information 10 when available.

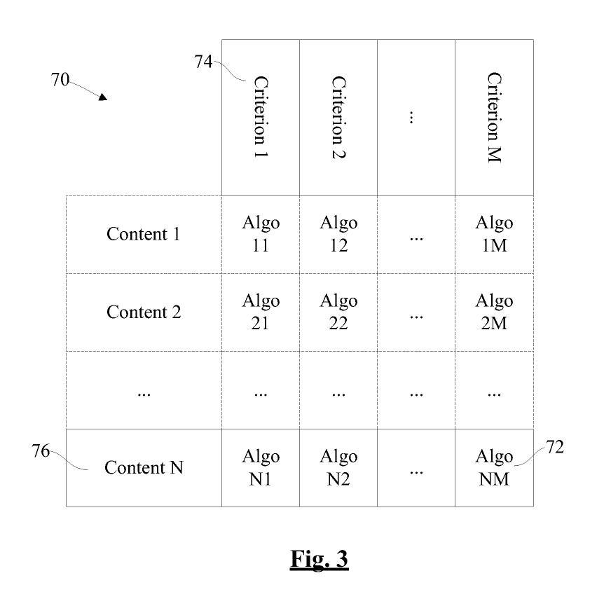

FIG. 2 illustrates a node 20 in a telecommunications system. The node can be any device such as a server, a general use computer, a mobile user device or any other type of computing machine. The node 20 comprises a memory 22 containing a plurality of contents, which, as will be explained below, may comprise advertisement. The node 20 comprises an access module 24, for accessing mobile user information 10 corresponding to criteria relative to the plurality of contents. The node 20 further comprises a processing module 26 for selecting the content for using in the mobile user device 50.

As stated before, the information 10 may be retrieved from the node 20 in totality or in part. In the case where the node 20 is a server, the information may be retrieved from the memory 22 of the server itself, from the mobile user device 50 or from any secondary node 60 in the telecommunications system. In cases where the information is retrieved from the mobile user device 50 or from a secondary node 60, the access module 24 may receive mobile user information 10 upon sending a request for receiving the information to the mobile user device 50 or to the secondary node 60. In the case the node 20 is the mobile user device 50, itself, the information may be retrieved from the memory 22 of the node 20 or from any secondary node 60 in the telecommunications system. The case where the node 20 would be a first mobile user device selecting content for a second mobile user device 50 may also be contemplated.

The memory 22 of the node 20 comprises a database 28 containing the plurality of contents. As it would be apparent to a person skilled in the art, the database could take any suitable form. The word “database” is used in a generic way as meaning any means of storing data.

If the node 20 is not the mobile user device, but is an external server or computer, the content selected may be communicated to the mobile user device, upon selection. In order to do so, the node 20 and the mobile user device 50 may be able to exchange messages such as Short Message Service (SMS), Multimedia Messaging Service (MMS), Internet Protocol Multimedia Subsystem Messaging (IMS-M), Web mail, emails or any other equivalent types of messages. Any of these types of messages may also be used to communicate the mobile user information 10 to the node 20.

Furthermore, some content of the plurality of contents may have to be updated from time to time. An example of such content could be movie show times. This could be done automatically, through the use of search engines or of any other tool connecting the node 20 to the internet, for example. Search engines, web services, other web interfaces or the like could further be used to retrieve current weather conditions at the current location of the mobile user device, for example. The current weather conditions could then be used as part of the mobile user information. Furthermore, the internet may also be used to enhance the content selected, by adding more recent pictures, content, etc. or may be used for treating or analyzing some information retrieved from the mobile user device.

The selection of the content for use in the mobile user device is based on a total score calculated for each content of the plurality of contents. The total score of each content is calculated by adding correspondence scores, which are calculated as reflecting a correspondence between the criterion and the mobile user information corresponding to that criterion.

Before calculating the total score, each correspondence score of the content may be normalized and/or multiplied by a weight relative to each criterion. The weight may be equal to zero. Furthermore, the correspondence scores, the normalized correspondence scores or the total score may be modified to reflect an uncertainty related to the mobile user information. The content selected may be the content having the greatest total score. However, other criteria could be used to select the content.

The mobile user device information may contain heterogeneous sources of information as well as other contextual information relative to the environment of the mobile user device and any other pertinent information. For example, the mobile user information may comprise a user current location, a user age, a user preference setting, a user text input, a user generated text message, a user received text message, or any other information, as it would be apparent to a person skilled in the art.

The method of selection of the content is intended to be scalable and to cover multiple dimensions of data. It is designed to find the best match between content and the very heterogeneous user mobile information, such as textual data and approximate user location. The method of selection of content is easy to extend when newer sources of information become available and still works when some pieces of information are not available. In such a case, for example, the weight corresponding to the criterion for which the piece of information is missing may be set to zero.

The processing module 26 may use an algorithm 72 specific to the criterion 74, specific to the content 76 or specific to both the criterion 74 and the content 76 for calculating the correspondence score, as shown in FIG. 3. Of course, the same algorithm for a particular criterion could be used for this particular criterion for all the contents. In such a case, table of FIG. 3 may often contain only one row 70 with algorithms applying for every content. There need not be a different algorithm for each content, but it is possible to have a specific algorithm for any criterion of any content. The algorithms specific to the criterion or content may be stored in a standalone database 28, as shown in FIG. 2, in a memory 22 of the node 20. The database 28 may be accessible in writing for modifying the algorithm, therefore, content managers may modify one of more specific algorithms at any time.

The plurality of contents may also be stored in a database in 28 in the memory 22 of the node 20. The database containing the algorithms may be the same database as the database containing the contents or may be a separate database. Furthermore, these databases may also be located in secondary nodes 60.

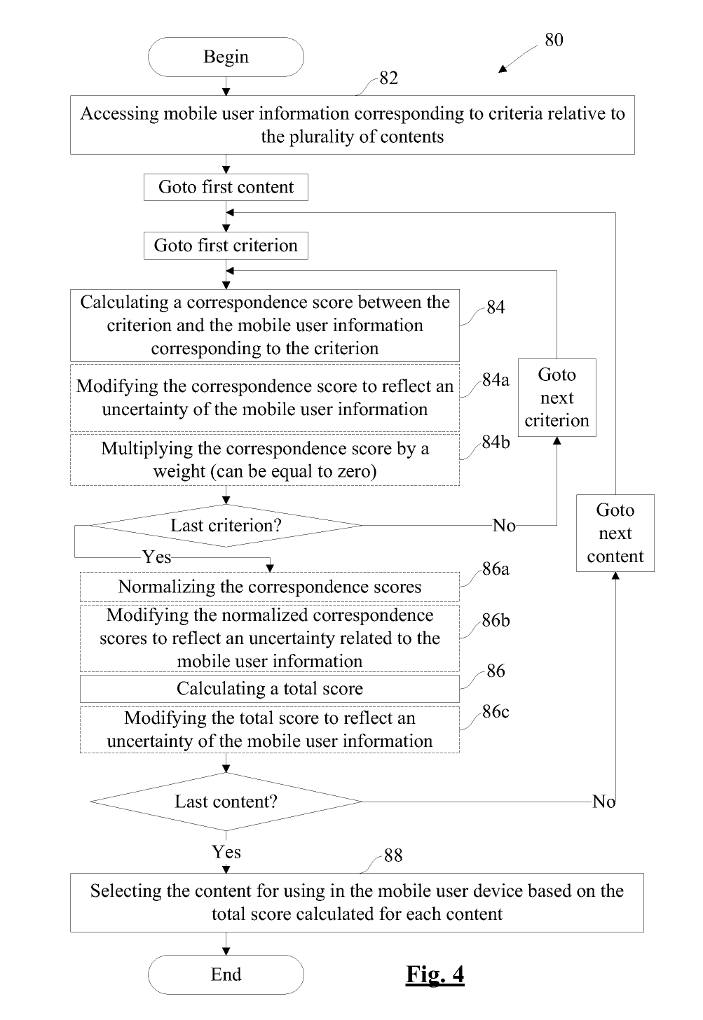

FIG. 4 illustrates the steps of a method 80 for selecting one of a plurality of contents for use in a mobile user device. The method comprises the step of accessing mobile user information corresponding to criteria relative to the plurality of contents, step 82. The step of accessing mobile user information may comprise receiving mobile user information upon sending a request for receiving the information. The method also comprises the following steps, executed for each content of the plurality of contents: calculating a correspondence score between each criterion of the content and the mobile user information corresponding to each criterion, step 84, and calculating a total score by adding the correspondence scores of the content, step 86. The method also comprises the step of selecting the content for using in the mobile user device based on the total score calculated for each content, step 88.

The step of calculating a correspondence score 84 may comprise modifying the correspondence score to reflect an uncertainty related to the mobile user information, step 84a. The step of calculating the correspondence score may comprise multiplying the correspondence score by a weight relative to the criterion, step 84b. The weight may be equal to zero for at least one criterion. The step of calculating a correspondence score 84 may comprise using an algorithm specific to the criterion, the content or both the criterion and the content for calculating the correspondence score. The algorithm specific to the criterion or the content may be stored in a standalone database in a memory of the server, the database being accessible in writing for modifying the algorithm. The plurality of contents may be stored in a database in a memory of the server.

The step of calculating the total score 86 may comprise the steps of calculating normalized correspondence scores by normalizing each correspondence score, step 86a, of the content and calculating a total score by adding the normalized correspondence scores of the content. The step of calculating normalized correspondence scores may comprise modifying the normalized correspondence scores to reflect an uncertainty related to the mobile user information, step 86b. The step of calculating a total score may comprise modifying the total score to reflect an uncertainty related to the mobile user information, step 86c.

The step of selecting the content, step 88, may comprise selecting the content having the greatest total score. However, other criteria could be used to select the content, such as a combination of the total score and a number of times the Ad was already presented to the user. The mobile user information may comprise a user current location, a user age, a user preference setting, a user text input, a user generated text message, a user received text message, or any pertinent data such as, for example, other user related data used for post-processing for Ad selection such as a maximum number of Ads a user can receive per day, a maximum number of time an user can receive an Ad, per day, etc.

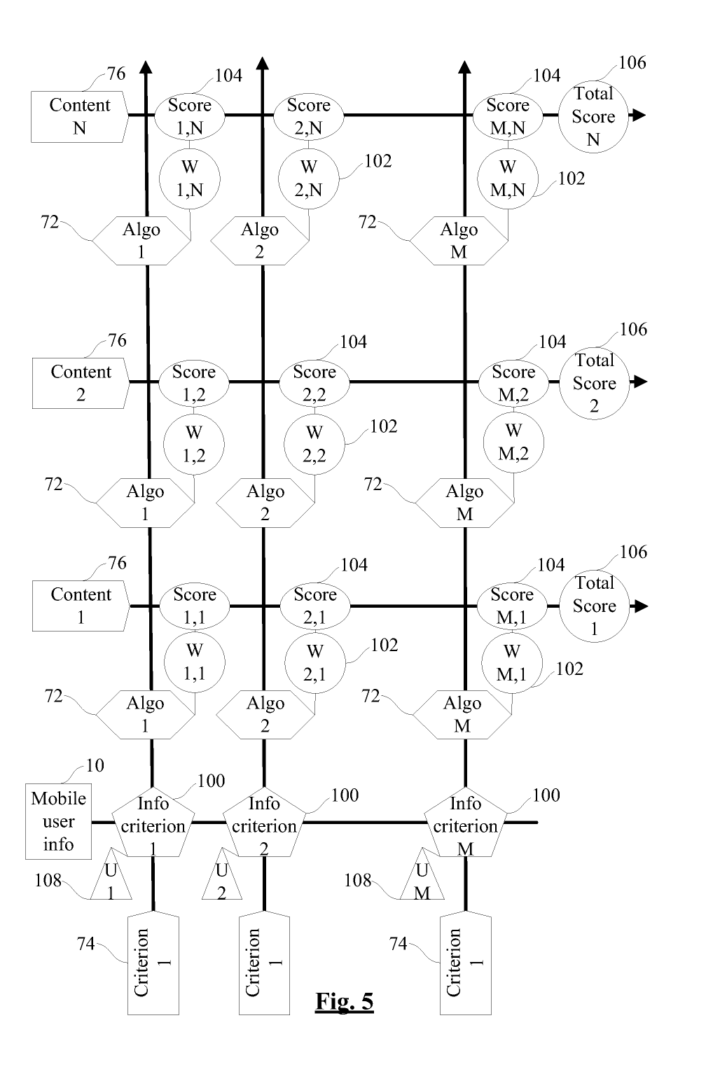

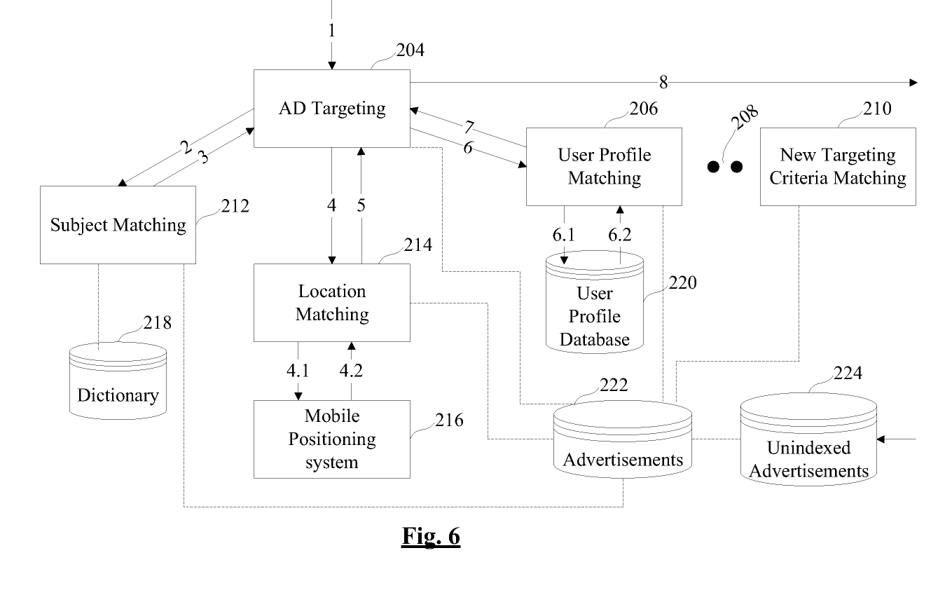

FIG. 5 illustrates an exemplary embodiment of the method of the present invention, which will now be described in details. This exemplary embodiment is provided in the context of advertisement (Ad) and more specifically, in the context of selecting an Ad for use in a mobile user device. In order to do so, advertisers have to create or upload their advertisements as well as criteria relative to the Ads in a database. The criteria for this particular example could be the age group, the gender, the income of the user of the mobile device, the location of the mobile device, a particular search query or a link clicked by the user, an event in the system or the current date for comparison with validity dates of the advertisements. The mobile user information forms a context, which may be suitable for presenting at least one of the advertisements to the user.

In FIG. 5 the vertical lines represent criteria 74 and the horizontal lines generally represent contents 76. The mobile user information 10 is represented by the bottom horizontal line and contains M criteria information 100. To each criteria information 100 may be attached an uncertainty 108. The criteria information 100 are compared to corresponding criteria 74 of each content with the algorithms 72, using weights 102 and producing scores 104. The scores 104 for each line are added, thus giving total scores 106, one for each content.

A criterion information 100 is a piece of information which can be compared, or matched, to the criterion 74 of each content 76, using the corresponding algorithm 72. The algorithm computes a correspondence score 104. In this example, the same algorithm is used for the same criterion of each content. However for a particular criterion, there could be different algorithms for each or for some of the contents. In the present case, the correspondence score would be a number. However, other types of scores may be contemplated. Each score 104, computed by the algorithm, may be multiplied by a weight 102, which typically could range from 0 to 1 or which may be chosen according to another scale. The weights 102 may represent the relative importance of one targeting criterion versus another from the perspective of an advertiser. In a case where a criterion information would not be available, the weights 102 for this criterion could all be put to 0. Furthermore, the criterion information 100 may be accompanied by an uncertainty 108 which may be added, multiplied or used in any other suitable way by the algorithm 72 to modify the score 104, in order to reflect an uncertainty of the criterion information. For example, if cellular power triangulation is used as a method to determine the user device location, there is an uncertainty area where the user device could be positioned, even though the mobile position system might return a point. Therefore, there is an uncertainty attached to this criterion information. Finally, for each content 76, a total score is calculated. In this case, it could be the sum of the individual scores 104 of the content 76. These scores 104 may be normalized before being added. One way of choosing a content for sending to the mobile user device is to choose the content 76 having the greatest total score 106. The selection of the content could however be more sophisticated and could include a post processing enforcing non-linear rules and policies, or taking into account factors such as a maximum number of Ads allowed to be sent per advertiser or an amount of AD delivery that was paid for etc.

The formula used to compute the total score in the example of FIG. 5 is:

total score_{N}=w_{1,N}score_{1,N}+w_{2,N}*score_{2,N}+ . . . +w_{M,N}*score_{M,N}

FIG. 6 illustrates an exemplary system embodying the method of the present invention. This example illustrates how the method may be executed modularly. The numbers on the arrows show the time sequence of the different events. In this example, for every criterion, there is a sub-system implementing at least one algorithm for computing at least one correspondence score. For example, the sub-systems could comprise a subject matching sub-system 212, a location matching sub-system 214 and a user profile matching sub-system 206. Such a system is not limited and could comprise more or less sub-systems. Each of these sub-systems would take as input some criterion information and match it against the corresponding criterion of the Ads. These subsystems 212, 214, 206 and the Ad targeting 204 may be executed in the processing module 26 of the node 20 of FIG. 2, for example. Furthermore, the databases 218, 220, 222 and 224 may be stored in the memories 10, 28 or 62 illustrated in FIG. 2, for example.

The sequence of events of FIG. 6 will now be described with reference to the numbers of the arrows on this figure:
Arrow 1—The mobile user information is received in the Ad targeting module 204. The information can take the form of a message (SMS, MMS, email, etc.) or any other suitable form.
Arrow 2—Criterion information relative to the message is sent to the subject matching 212 for evaluation. If the criterion information has the form of a text, it may be verified against a dictionary 218 for the correction of errors, typos, slang, etc. The subject matching module 212 accesses the Advertisements database 222 and proceeds to comparing, by keywords matching, for example, the criterion information against the criterion of the Ads and to compute correspondence scores.
Arrow 3—The subject matching module 212 returns the results, i.e. the correspondence score of the criterion information with the criterion, to the Ad targeting module 204.
Arrow 4—Criterion information relative to the location of the subject is sent to the location matching 214 for evaluation. The location matching module 214 accesses the Advertisements database 222 and proceeds to comparing, by location coordinates matching for example, the criterion information against the criterion of the Ads and to compute correspondence scores.
Arrow 4.1—If the current location of the mobile user device is not known, it can be fetched by the system with the Mobile Positioning System (MPS). The MPS can comprise Global Positioning System (GPS), Internet Protocol (IP) address, Cell Positioning etc.
Arrow 4.2—The location is then returned to the location matching module 214.
Arrow 5—The location matching module 214 returns the results, i.e. the correspondence scores of the criterion information with the criterion, to the Ad targeting module 204.
Arrow 6—Criteria information relative to the user profile of the subject is sent to the user profile matching 206 for evaluation. The user profile matching module 206 accesses the Advertisements database 222 and proceeds to comparing, by keywords matching or by range matching for criteria such as age and income, for example, the criteria information against the criteria of the Ads and to compute correspondence scores.
Arrow 6.1—If the current user profile is not known, it can be fetched in the user profile database 220.
Arrow 6.2—The current user profile of the user is then returned to the profile matching module 206. The user profile may comprise information such as points of interest and generated profile information such as age, sex, income, preferred movies, marital status etc.
Arrow 7—The profile matching module 206 returns the results, i.e. the correspondence scores of the criteria information with the criteria, to the Ad targeting module 204.
Arrow 8—The Ad targeting module selects an Ad among the Ads of the database 222. The selection can be made by selecting the Ad having the highest total score. Another selection function could be used as well, for example in the case two Ads would get the same score, another function could select a winning Ad.

The double dots 208 of FIG. 6 represent new matching criteria which could be added. Corresponding new matching modules which could also be added are represented by the box 210. This illustrates that many other matching modules could be added to the system. Furthermore, the unindexed advertisement database 224 contains advertisements created by advertisers but not yet active or indexed.

In the exemplary embodiment of FIG. 6, advertisement criteria may include keywords specified by the advertiser for describing the subject of the AD. The mobile user device information may contain the text content of the body of a message (SMS, MMS, IMS-M, email or proprietary chat applications) sent from one person to another. The output of each of the subsystems may be an array with the correspondence scores (which could be normalized to be a floating point number between 0 and 1) for each of the Ads in the Ads database 222. Further as part of the Ads database, the advertiser may have specified the relative importance of each targeting criterion, for which the individual weight would have added up to 1. The weights may be different for each Ad, depending on the relative importance of each criterion to each advertiser. Furthermore, more targeting criteria and their physical implementation may be added at any time. The same weighted sum mechanism may be extended easily.

Further to what was described previously, the invention also provides a formula for normalizing the matching scores for text queries:

score_{1,N}=Log₂(1+(((1−(1/(overlap_{1,N}+1)))⁻ⁿ)

The log scale and the exponent n, where n may be equal to 2, are used to control the distribution of weights without modifying the original relevance order from overlap i.e the number of words or keywords matched in the text. For example, how many keywords for an Ad match to the words of a user message. The exponent n controls how closely the scores are distributed relatively to each other, while the log base scale can shift the mean distribution from 0 to 1.

For example, let us assume that there is a faulty algorithm for keyword matching which returns a 0.1 score for most keywords and that there is an algorithm for location matching which returns a perfect score of 1 most of the time. Let us also assume that the advertiser would like to put equal importance to the keywords match and to the location match so weights of 0.5 and 0.5 are assigned respectively. The total score calculated with the formulae of paragraph 40 would be 0.5 * 0.1+0.5 * 1=0.55, where a large amount of the total score would be contributed from the location matching. In this example, this is clearly not what the advertiser requested when assigning his weights. Therefore, for the weights to be meaningful, the matching metrics should be comparable amongst them. The equation of paragraph 45 provides a way to compute a score for keyword matching that is adjustable and more readily comparable to the score of the location matching.

The present invention may be used for the insertion of targeted advertisement in the body of a message sent from one mobile user device to another. Messaging in this context includes, but is not limited to, Short Messaging Service (SMS), Multimedia Messaging Service (MMS) and Internet Protocol Multimedia Subsystem Message (IMS-M). The mobile users involved in such an advertisement insertion scheme may explicitly opt-in with the incentive of a subsidized subscription from their operator, for example. The mobile users may control the nature of the advertisement targeting, the maximum number of advertisements they receive, they may provide feedback on the targeting and opt-out at any moment, which in-turn may affect the amount of discount or other incentives that they receive from the operator.

As an example, let us assume that User A sends a SMS asking User B for dinner with his mobile device. User B received a 2-slide MMS on his mobile device with the first slide exactly as the SMS text sent by User A and the second slide comprising a multimedia advertisement for an Italian restaurant 2 blocks away from where User B is currently located. From a messaging perspective, complete inter-working may be supported among all forms of messaging to allow for this AD insertion in combination with the user messaging preferences. In this example, the SMS was up-converted to an MMS because User B was MMS capable and that the advertisement was multimedia. Furthermore, the context and location targeting was used to find an Italian restaurant advertisement close to User B's current location. Any advertisement insertion, such as SMS to SMS, MMS to MMS, SMS to MMS, SMS to IMS-M, MMS to IMS-M as well as Email or other message formats could be supported.

In a larger perspective, an Ads targeting system may be used to find localized Ads, such as the nearest shop or restaurant relative to a mobile user. The message content may be filtered and keywords may be extrapolated, corrected and best matched to the context of the advertisement database. Subscriber profile containing information such as age, sex and income as well as areas of interest or preferences may also factors in the equation to ultimately find the most relevant advertisement. This targeting mechanism could also be extended to insert advertisements in voicemail notifications and could be extended to use voice messages or conversations information as inputs to the system.

Furthermore, certain advertisement campaigns may be triggered when a mobile user of the system enters a particular region such as a shopping mall, a large home hardware, electronics store or when a mobile user is near a particular location such as a restaurant. Under such condition, an advertisement which matches that particular location may be sent to the user as a SMS, MMS, IMS-M or Wireless Application Protocol-push, for example.

The present invention may also be used as a self-service content, to enable a mobile user to access rich multimedia content. The services offered may range from detailed weather information, news, movies schedule, stock quotes, mapping of local streets, locating a business and getting the up to date scores of favorite sports teams, for example. The services could be paid for by the end-user or subsidized by an appended advertisement, targeted based on the content of the self service requested, the geographical location or the mobile user profile.

Contrary to traditional self-service where there is a unique SMS short code for each type of Value Added Service (VAS) offered, a self-service approach as described herein may only need to have a single number to send the VAS request. To provide different type of VAS, an intuitive and configurable command may be specified for the VAS request. An example of command could be “weather Montreal” which would give the detailed weather information for the next few days for the town of Montreal. Furthermore, some of the parameters could be inferred if the end-user does not specify them. With just entering “weather” for instance, the system could locate the positioning information of the mobile user device and send back the weather information for the town where the user is currently located.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

1. A node in a telecommunications system, comprising:
a memory containing a plurality of contents;
an access module, for accessing mobile user information corresponding to criteria relative to the plurality of contents; and
a processing module for selecting a content for using in a mobile user device based on a total score calculated for each content of the plurality of contents, the total score of each content being calculated by adding correspondence scores calculated between each criterion and the mobile user information corresponding to each criterion.

2. The node of claim 1, wherein the processor calculates the total score by adding normalized correspondence scores calculated by normalizing each correspondence score of the content.

3. The node of claim 1, wherein the processing module multiplies the correspondence score by a weight relative to the criterion.

4. The node of claim 1, wherein the processing module modifies the correspondence scores to reflect an uncertainty related to the mobile user information.

5. The node of claim 2, wherein the processing module modifies the normalized correspondence scores to reflect an uncertainty related to the mobile user information.

6. The node of claim 3, wherein the weight is equal to zero for at least one criterion.

7. The node of claim 1, wherein selecting the content comprises selecting the content having the greatest total score.

8. The node of claim 1, wherein mobile user information comprises a user current location.

9. The node of claim 1, wherein mobile user information comprises at least one of a user age, a user preference setting, a user text input, a user generated text message and a user received text message.

10. The node of claim 1, wherein the processing module uses an algorithm specific to each criterion for calculating the correspondence score.

11. The node of claim 1, wherein the processing module uses an algorithm specific to the content for calculating the correspondence score.

12. The node of claim 10, wherein the algorithm specific to each criterion is stored in a standalone database in a memory of the node, said database being accessible in writing for modifying the algorithm.

13. The node of claim 11, wherein the algorithm specific to the content is stored in a standalone database in a memory of the node, said database being accessible in writing for modifying the algorithm.

14. The node of claim 1, wherein the plurality of contents is stored in a database in a memory of the node.

15. The node of claim 1, wherein the access module receives mobile user information upon sending a request for receiving said information.

16. The node of claim 1, wherein the node is the mobile user device.

17. The node of claim 1, wherein the node is a server.

18. A method for selecting one of a plurality of contents for use in a mobile user device, said method comprising the steps of:
a) accessing mobile user information corresponding to criteria relative to the plurality of contents;
b) performing the following steps for each content of the plurality of contents:
i. calculating a correspondence score between each criterion of the content and the mobile user information corresponding to each criterion; and
ii. calculating a total score by adding the correspondence scores of the content; and
c) selecting the content for using in the mobile user device based on the total score calculated for each content.

19. The method of claim 18, wherein the step of calculating the total score comprises the steps of:
iii. calculating normalized correspondence scores by normalizing each correspondence score of the content; and
iv. calculating a total score by adding the normalized correspondence scores of the content.

20. The method of claim 18, wherein the step of calculating the correspondence score comprises multiplying the correspondence score by a weight relative to each criterion.

21. The method of claim 18, wherein the step of calculating a correspondence score comprises modifying the correspondence score to reflect an uncertainty related to the mobile user information.

22. The method of claim 19, wherein the step of calculating normalized correspondence scores comprises modifying the normalized correspondence scores to reflect an uncertainty related to the mobile user information.

23. The method of claim 20, wherein the weight is equal to zero for at least one criterion.

24. The method of claim 18, wherein the step of selecting the content comprises selecting the content having the greatest total score.

25. The method of claim 18, wherein mobile user information comprises a user current location.

26. The method of claim 18, wherein mobile user information comprises at least one of a user age, a user preference setting, a user text input, a user generated text message and a user received text message.

27. The method of claim 18, wherein the step of calculating a correspondence score comprises using an algorithm specific to each criterion for calculating the correspondence score.

28. The method of claim 18, wherein the step of calculating a correspondence score comprises using an algorithm specific to the content for calculating the correspondence score.

29. The method of claim 27, wherein the algorithm specific to each criterion is stored in a standalone database in a memory of the node, said database being accessible in writing for modifying the algorithm.

30. The method of claim 28, wherein the algorithm specific to the content is stored in a standalone database in a memory of the node, said database being accessible in writing for modifying the algorithm.

31. The method of claim 18, wherein the plurality of contents is stored in a database in a memory of the node.

32. The method of claim 18, wherein the step of accessing mobile user information comprises receiving mobile user information upon sending a request for receiving said information.
